(19) United States
(12) Patent Application Publication
(10) Pub. No.: US 2026/0235752 A1
(43) Pub. Date: Aug. 13, 2026

(54) Echolocation Wearable Probe

(71) Applicant: Board of Regents, The University of Texas System, Austin, TX (US)

(72) Inventors: Aisen C. Chacin, Galveston, TX (US); Praveena Kumari Gupta, Galveston, TX (US)

(21) Appl. No.: 19/535,684

(22) Filed: Feb. 10, 2026

Related U.S. Application Data
(60) Provisional application No. 63/757,120, filed on Feb. 11, 2025.

(51) Int. Cl. G01S 15/88

(52) U.S. Cl. CPC G01S 15/88

(57) ABSTRACT

A wearable echolocation system includes a set of ultrasonic transducers configured to emit parametric sound waves, and an enclosure containing the set of ultrasonic transducers. The enclosure is configured to be worn by a user without obscuring vision of the user. In addition, a method includes providing the wearable echolocation system to the user without obscuring a vision of the user, generating and emitting parametric sound waves using the set of ultrasonic transducers, receiving a reflected sound from one or more objects in response to the parametric sound waves, and detecting the one or more objects using the reflected sound.

### CROSS-REFERENCE TO RELATED APPLICATIONS

This application claims priority to U.S. Provisional Application Ser. No. 63/757,120 filed Feb. 11, 2025, the entire contents of which are incorporated herein by reference.

### TECHNICAL FIELD OF THE INVENTION

The present invention relates to navigational guides for visually impaired persons, and more specifically to a system and method for an echolocation wearable probe.

### STATEMENT OF FEDERALLY FUNDED RESEARCH

Not applicable.

### BACKGROUND OF THE INVENTION

Visual impairment such as blindness is a disability that is only expected to become more prevalent with aging populations. Many visually impaired persons lack the ability to navigate independently. Some navigational aids rely on ultrasonic range finding to create distance perception for visually impaired persons. Distance perception alone has been too limiting for visually impaired persons to spatially navigate. Certain navigational aids rely on image recognition and signal processing to produce chirps to alert visually impaired persons. Some image recognition aids rely on a camera attached to a helmet to be worn by a visually impaired person, which is awkward for mobility. Both range finding aids and image recognition aids have carried a high learning curve requiring significant time and effort for visually impaired persons to learn. Such navigational aids have also tended to overload a user's hearing. Range finding aids and image recognition aids consequently have been ineffective in enhancing the ability of visually impaired persons to navigate independently.

Certain navigational aids have relied on echolocation to help provide orientation and mobility for visually impaired persons. The Sunu Band is one example. Such navigational aids though depend on translating digital information from sensors resulting in a low fidelity experience for visually impaired persons. Thus, echolocation has remained underutilized as a potential clinical aid for visually impaired persons.

### SUMMARY OF THE INVENTION

In one embodiment of the present disclosure, a wearable echolocation system includes a set of ultrasonic transducers configured to emit parametric sound waves, and an enclosure containing the set of ultrasonic transducers. The enclosure is configured to be worn by a user without obscuring vision of the user.

In one aspect, the enclosure is configured to be worn with a lanyard. In another aspect, the enclosure is configured to be coupled to a mobility aid. In another aspect, the enclosure is handheld. In another aspect, the enclosure does not interfere with a user's ability to navigate in an environment. In another aspect, the parametric sound waves include a white noise or version thereof, one or more desired sound frequencies or a customizable audio pattern. In another aspect, the system further includes an analog synthesizer coupled to the set of ultrasonic transducers, wherein the analog synthesizer modulates a frequency of the parametric sound waves based on light or sound information. In another aspect, the system further includes a photoresistor coupled to at least one of the analog synthesizer, or a digital audio interface, wherein the photoresistor provides the light information. In another aspect, the system further includes a microphone. In another aspect, the microphone is configured to generate a directional sound signature of the user. In another aspect, the system further includes a headphone communicably coupled to an auxiliary port which is communicably coupled to the microphone, wherein the microphone is configured to record a reflected audible signal from an environment that is provided to the headphone via the auxiliary port. In another aspect, the system further includes an audio amplifier coupled to the analog synthesizer. In another aspect, the system further includes a microcontroller coupled to the audio amplifier and the set of ultrasonic transducers. In another aspect, the system further includes a digital audio player and volatile memory card reader coupled to the analog synthesizer. In another aspect, the system further includes a microphone that captures the echolocation signal (the reflected sound). In another aspect, the system contains a microcontroller that processes the echolocation signal and exports the processed sound to an auxiliary port. In another aspect, the system contains an auxiliary port that can be connected to a headphone. In another aspect, the system contains a voltage control oscillator for frequency tunning to drive the set of ultrasonic transducers. In another aspect, the system contains audio controls and voltage regulators. In another aspect, the system contains an audio interface with potentiometers. In another aspect, the system can be coupled to another device with a Bluetooth signal.

In one embodiment of the present disclosure, a method of providing a wearable echolocation for a user includes providing the wearable echolocation system to the user without obscuring a vision of the user, wherein the wearable echolocation system comprises a set of ultrasonic transducers configured to emit parametric sound waves, and an enclosure containing the set of ultrasonic transducers. The parametric sound waves are generated and emitted using the set of ultrasonic transducers. A reflected sound from one or more objects is received in response to the parametric sound waves, and the reflected sound is provided to the user.

In one aspect, the reflected sound contains varying wavelengths depending on a distance of the one or more objects and the ultrasonic tranducers. In another aspect, the parametric sound waves are directional or focused. In another aspect, the parametric sound waves include a recorded or customizable audio pattern. In another aspect, the method further includes modifying the parametric sound waves. In another aspect, the method further includes modulating a frequency of the parametric sound waves based on detected light level(s). In another aspect, the parametric sound waves include a white noise or version thereof, one or more desired sound frequencies or a customizable audio pattern. In another aspect, the user uses the reflected sound to avoid the one or more objects. In another aspect, the parametric sound waves include a digital sound source. In another aspect, the parametric sound waves include a signal generated by the user and captured by a microphone. In another aspect, the parametric sound waves include an ultrasonic carrier wave that oscillates at 40 KHz and carries an audible audio signal generated by the user. In another aspect, the voltage is inverted to switch the polarity of the transducers to produce the audible signal that is directional. In another aspect, the user and/or the microphone detect the audible signal (the reflected sound or echolocation signal) from the point of reflection of the audible wave as it collides with its environment. In another aspect, the method further includes discerning objects based on their sound reflection signatures detected by the user.

### BRIEF DESCRIPTION OF THE DRAWINGS

Many aspects of the present disclosure can be better understood with reference to the following drawings, described below. The components in the drawings are not necessarily to scale, with emphasis instead being placed upon clearly illustrating the principles and data flow of the present disclosure. Furthermore, within the drawings, like reference numerals designate corresponding parts throughout the several views presented.

FIG. 1 is a forty-five-degree view of a wearable echolocation device in accordance with one embodiment of the present disclosure;

FIG. 2 is a side view of the wearable echolocation device of FIG. 1;

FIG. 3 is an exploded top view of an engineering diagram of a wearable echolocation device in accordance with one embodiment of the present disclosure;

FIG. 4 is an exploded side view of an engineering diagram of the wearable echolocation device of FIG. 3;

FIG. 5 illustrates a lanyard embodiment of a wearable echolocation device device in accordance with one embodiment of the present disclosure;

FIG. 6 illustrates a walking cane embodiment of a wearable echolocation device in accordance with one embodiment of the present disclosure;

FIG. 7 illustrates a device harness embodiment of a wearable echolocation device in accordance with one embodiment of the present disclosure;

FIG. 8 is a flow chart of a method in accordance with one embodiment of the present disclosure;

FIG. 9A is a gait tracking illustration for a visioned individual;

FIG. 9B is a gait tracking illustration for a simulated low vision individual;

FIG. 9C is a gait tracking illustration for a simulated low vision individual using a wearable echolocation device in accordance with one embodiment of the present disclosure; and

FIG. 10 is an image of a breadboad circuit showing some of the components of a wearable echolocation device in accordance with one embodiment of the present disclosure.

### DETAILED DESCRIPTION

Certain aspects and embodiments of the present technology are directed to teaching echolocation to visually impaired individuals to help navigate their environment and mitigate fall risks. The systems and methods described herein may comprise a wearable echolocation device that emits a directional or focused beam of parametric sound generating a sonic imprint, map or topography of the environment for a visually impaired individual to hear to discern objects in the environment. The wearable echolocation device may assist with the principle of sensory compensation, namely the phenomenon whereby the brain compensates by enhancing the functions of other sensory organs. The wearable echolocation device may better assist users in developing auditory spatial perception. The wearable echolocation device may provide users with enhanced spatial awareness of the environment thereby reducing fall risks and enhancing the ability of users to navigate independently. The wearable echolocation device may function like a sonic flashlight for increasing the mobility of visually impaired individuals. As opposed to obscuring the vision of a visually impaired individual, the wearable echolocation device can act as a supplement to one's own vision thereby providing the individual with more control and freedom of use. The wearable echolocation device may enable a visually impaired individual to develop echolocation skills.

In some embodiments, the wearable echolocation device includes parametric speakers housed in a plastic case. The parametric speakers emit directional sound waves that return with varying wavelengths depending on the distance of the surrounding objects. In some embodiments, the parametric speakers comprise an ultrasonic array of transducers. For example, the speakers can be implemented using the Tri-State Parametric Speaker Kit or a custom circuit. The parametric sound enables a visually impaired individual to detect ultrasound waves as they reflect off surroundings and return to the individual's ears in patterns that reveal the sonic imprint of the environment. The ultrasound carries an audible sound wave that collides with the environment and reflects off the surrounding surfaces to display the audible sound.

In certain embodiments of the wearable echolocation device, the parametric or directional sound is generated from an ultrasonic carrier wave of 40,000 Hz. The carrier wave demodulates in air or as the wave collides with an object. The parametric or directional sound serves to warn a visually impaired individual of obstacles in advance of encountering them, aiding in safer mobility.

In some embodiments, the wearable echolocation device is light weight approximating the size and weight of a typical mobile phone. In certain embodiments, the wearable echolocation device is sufficiently light weight as to avoid interfering with the user's ability to safely navigate the environment.

In some embodiments, the wearable echolocation device may include an analog synthesizer using a photo resistor as a reference input signal for lighting conditions giving an extra layer of information about visual cues. In some embodiments, the device may include a microcontroller enabling the input to be digital or analog. In certain embodiments, the wearable echolocation device may include a small microphone whereby inputs are variable and responsive to other cues of the environment.

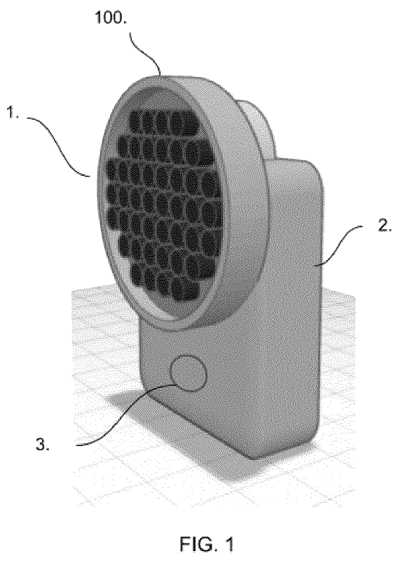

Referring to FIG. 1, a wearable echolocation device 100 in accordance with one embodiment of the present disclosure is shown. The wearable echolocation device 100 includes a set of ultrasonic transducers 1 contained in an enclosure 2, which can be a plastic case for example. The enclosure 2 also includes a play/pause button 3 for a user to activate (or play) or deactivate (or pause) the sound emitted by the ultrasonic transducers 1.

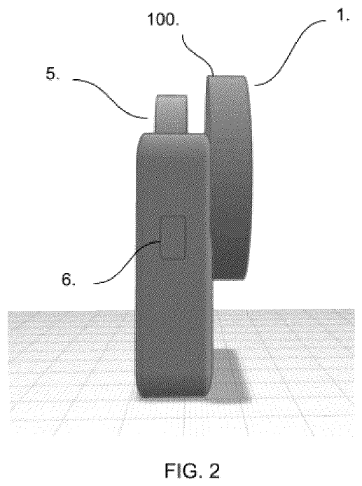

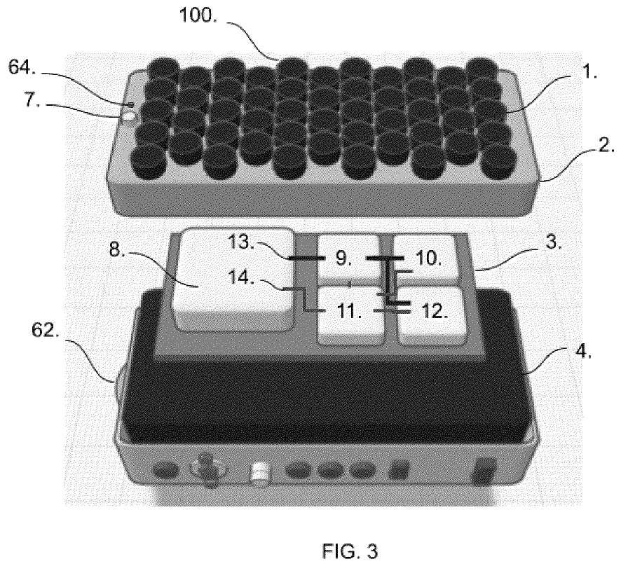

Referring to FIG. 2, the wearable echolocation device 100 in accordance with one embodiment of the present disclosure is shown. The wearable echolocation device 100 includes the set of ultrasonic transducers 1 and further includes a lanyard holder 5 and an on/off switch 6. The lanyard holder 5 serves to hold a lanyard so that the wearable echolocation device 100 may be worn by a user. For example, the device 100 may hang or be disposed in the chest area of the user. Other types of holders, fasteners or connectors can be used so that the device 100 is wearable. Because the wearable echolocation device 100 is worn on a lanyard, strap, chest strap, clip, magnetic attachment or other suitable attachments, the device does not obscure any remaining vision of the user and can be temporarily handheld for ease of use. When the on/off switch 6 is in an on state, a battery (shown in FIG. 3 and discussed below) activates power to the wearable echolocation device 100. When the on/off switch 6 is in an off state, the battery deactivates power to the device 100.

Referring to FIG. 3, the wearable echolocation device 100 in accordance with one embodiment of the present disclosure is shown. The wearable echolocation device 100 includes the set of ultrasonic transducers 1, the enclosure 2, a printed circuit board 3, a battery 4, a hook 62, a microphone 7, a microcontroller 8, an audio amplifier 9, a digital audio player and volatile memory card reader 10, a power supply 11, an analog synthesizer 12, an audio connection sequence line 13, a power connection sequence line 14, and a photoresistor 64. The battery 4 can be a rechargeable 12v battery. The battery 4 can be recharged from an external power source or a small solar panel. The hook 62 can for example be a semicircular ring to accommodate a lanyard. The photoresistor 64 can act as a light sensor that detects the light levels and sources in the environment. The microcontroller 8 controls generation, playback, modulation, demodulation, and amplification of sound from the set of ultrasonic transducers 1. The audio amplifier 9, which is coupled to the set of ultrasonic transducers 1, amplifies the sound from the set of ultrasonic transducers 1. The digital audio player and volatile memory card reader 10, which are coupled to the set of ultrasonic transducers 1, controls playback of sounds stored on a memory card. The memory card reader 10 can be an SD card reader for example. The power supply 11 serves to distribute power among the circuit, stepping up or down the voltage required for each component of the device 100, allowing for only one power source for the device 100. The analog synthesizer 12, which is coupled to the set of ultrasonic transducers 1, serves to provide an alternative audio signal that can be modulated by the user to create the user's own sound signature. Using the analog synthesizer 12, the user can add more or less noise, generate an audio wave at a desired frequency, and/or create customizable audio patterns. Based on light information from the photoresistor 64, the analog synthesizer 12 can modulate the frequency of the parametric sound waves emitted by the set of ultrasonic transducers 1 to produce an audio signal that provides information about the light levels and sources in the environment. For example, the parametric sound waves may include a white noise or version thereof, one or more desired sound frequencies or a customizable audio pattern, or any other audio output. The audio connection sequence line 13 shows the coupling of the audio amplifier 9, the digital audio player and volatile memory card reader 10, and the analog synthesizer 12. The power connection sequence line 14 shows the coupling of the power supply 11, the analog synthesizer 12, and the digital audio player and volatile memory card reader 10. The microphone 64 is a small microphone to provide the user with the ability to make their own sound that can be produced by the set of ultrasonic transducers 1, giving the user the ability to generate their own directional sound signature. For example, the small microphone can be a microphone that is a condenser microphone that can augment the voice of the user in real time or allow for the user's voice to be recorded and replayed on a loop.

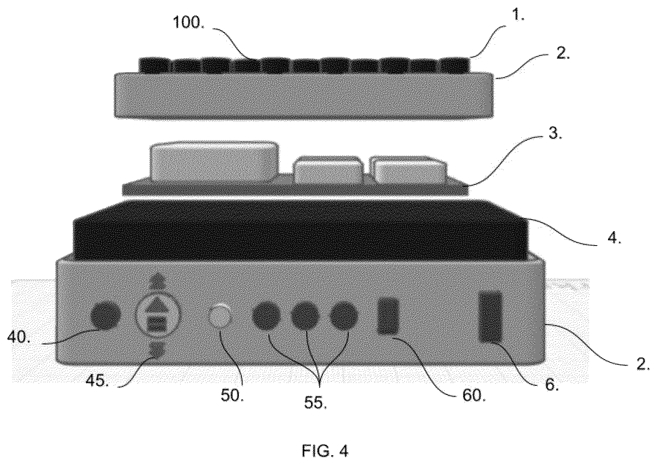

Referring to FIG. 4, the wearable echolocation device 100 in accordance with one embodiment of the present disclosure is shown. The wearable echolocation device 100 includes the set of ultrasonic transducers 1, the enclosure 2, the printed circuit board 3, the battery 4, a volume control 40, a digital audio interface 45, an analog/digital mode switch 50, an analog audio interface 55, a noise on/off switch 60, and the on/off switch 6. The volume control 40 controls the volume of the parametric or directional sound produced by the set of ultrasonic transducers 1. The analog/digital mode switch 50 switches the wearable echolocation device between an analog mode and a digital mode. The digital audio interface 45 receives a digital audio signal. The analog audio interface 55 receives an analog audio signal. In the digital mode, the digital audio interface 45 is used, and in the analog mode, the analog audio interface 55, which may include potentiometers, buttons or input controllers, is used. For example, the analog audio interface 55 can include potentiometers to modulate the frequency of the analog audio signal. The noise on/off switch 60 is used to activate or deactivate generation of noise produced by the set of ultrasonic transducers 1.

Referring to FIG. 5, the wearable echolocation device 100 in accordance with one embodiment of the present disclosure is shown. The wearable echolocation device 100 includes a set of ultrasonic transducers 1. The device 100 is suspended or held in place in front of a user's chest by a lanyard 65. In this way, the parametric or directional sound generated by the set of ultrasonic transducers 1 is aimed in front of the user.

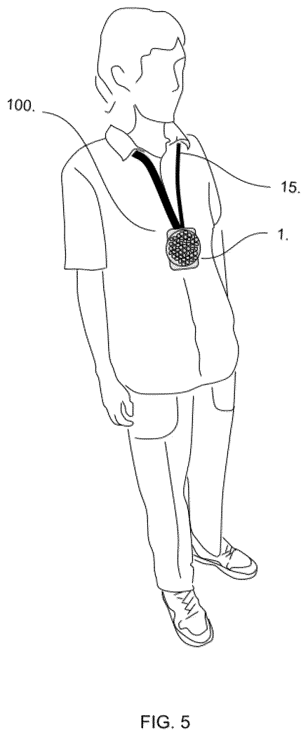

Referring to FIG. 6, a walking cane embodiment of a wearable echolocation device in accordance with one embodiment of the present disclosure is shown. An enclosure 70 is coupled to a walking cane 75. The enclosure 70 can be coupled to the walking cane 75 in a variety of ways. For example, a hinge or a rotary connector that allows angle adjustment could be used. The enclosure 70 includes the set of ultrasonic transducers 1. Like the lanyard embodiment of the wearable echolocation device, the walking cane embodiment results in the parametric or directional sound from the set of ultrasonic transducers 1 being aimed in front of the user. Note that the enclosure 70 can be coupled to other mobility aids, such as crutches, walkers, wheelchairs, scooters, or the like.

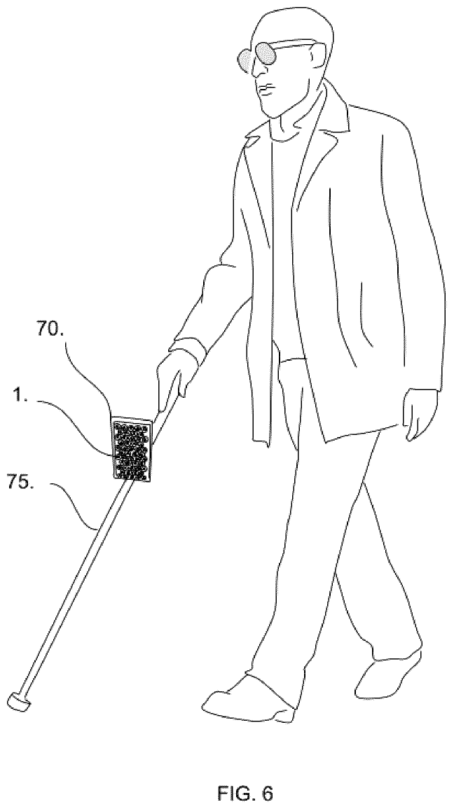

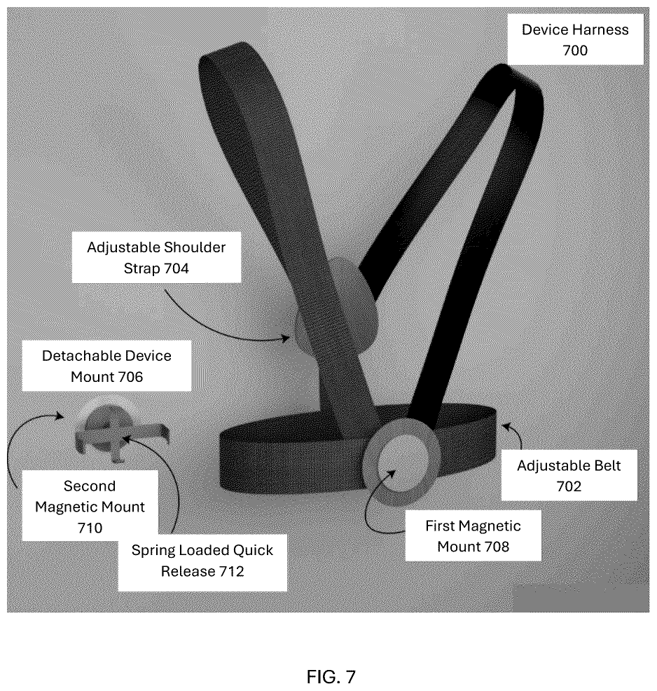

Referring to FIG. 7, a device harness 700 embodiment of a wearable echolocation device in accordance with one embodiment of the present disclosure is shown. The device harness 700 includes an adjustable belt 702 that goes around the waist of the user, an adjustable strap 704 that is attached the the adjustable belt 702 and goes around each shoulder of the user, and a detachable device mount 706. A first magnetic mount 708 is attached to a front side of the adjustable belt 702. The detachable device mount 706 includes a second magnetic mount 710 that is used to removeably secure the wearable echolocation device. The second magnetic mount 710 magnetically attaches to the first magnetic mount 708 and includes a spring loaded quick release 712. Note that in some embodiments, the adjustable shoulder strap 704 is not required and the magnetic mounts 708, 710 are replace with other fasteners.

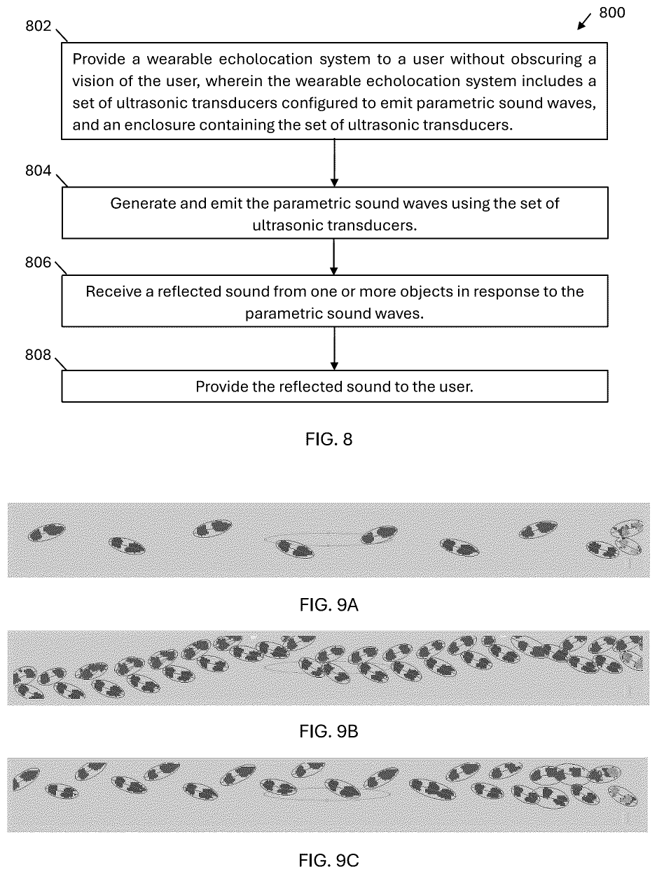

Referring to FIG. 8, a flow chart of a method 800 of providing a wearable echolocation device for a user in accordance with one embodiment of the present disclosure is shown. The wearable echolocation system is provided to the user without obscuring a vision of the user in block 802. The wearable echolocation system, such as described above in reference to FIGS. 1-7 includes a set of ultrasonic transducers configured to emit parametric sound waves, and an enclosure containing the set of ultrasonic transducers. The parametric sound waves are generated and emitted using the set of ultrasonic transducers in block 804. A reflected sound from one or more objects is received in response to the parametric sound waves in block 806. The reflected sound is provided to the user in block 808.

In one aspect, the reflected sound contains varying wavelengths depending on a distance of the one or more objects and the ultrasonic tranducers. In another aspect, the parametric sound waves are directional or focused. In another aspect, the parametric sound waves include a recorded or customizable audio pattern. In another aspect, the method further includes modifying the parametric sound waves. In another aspect, the method further includes modulating a frequency of the parametric sound waves based on detected light level(s). In another aspect, the parametric sound waves include a white noise or version thereof, one or more desired sound frequencies or a customizable audio pattern. In another aspect, the user uses the reflected sound to avoid the one or more objects. In another aspect, the parametric sound waves include a digital sound source. In another aspect, the parametric sound waves include a signal generated by the user and captured by a microphone. In another aspect, the parametric sound waves include an ultrasonic carrier wave that oscillates at 40 KHz and carries an audible audio signal generated by the user. In another aspect, the voltage is inverted to switch the polarity of the transducers to produce the audible signal that is directional. In another aspect, the user and/or the microphone detect the audible signal (the reflected sound or echolocation signal) from the point of reflection of the audible wave as it collides with its environment. In another aspect, the method further includes discerning objects based on their sound reflection signatures detected by the user.

Referring to FIG. 9A, a gait tracking illustration for a visioned individual on an electronic pressure mat is shown. The electronic pressure mat for example can be the Zeno-Walkway Gait Analysis system that automates the measuring of spatial and temporary parameters. The mat captures the relative geometry and applied pressure of each footfall of the user as a function of time. Each footfall of a visioned individual occurs along a central axis of the mat.

Referring to FIG. 9B, a gait tracking illustration for a simulated low vision individual on an electronic pressure mat is shown. In contrast to the footfall pattern of a visioned individual, each footfall of a simulated low vision individual strays substantially from the centra axis of the mat. Each such footfall also has significantly less spacing between the footfall of the right foot as compared to the footfall of the left foot.

Referring to FIG. 9C, a gait tracking illustration for a simulated low vision individual on an electronic pressure mat using a wearable echolocation device in accordance with the present disclosure (e.g., see FIGS. 1-7) is shown. The footfall of a simulated low vision individual using the wearable echolocation device is significantly improved as compared to the footfall of a simulated low vision individual lacking use of the wearable echolocation device. For example, the footfall pattern is closer to the central axis of the mat than the footfall pattern when the simulated low vision individual is not using the wearable echolocation device. Further, there is significantly more spacing between the footfall of the right foot and the footfall of the left foot when the simulated low vision individual is using the wearable echolocation device.

A study was conducted using a wearable echolocation device in accordance with one embodiment of the present disclosure. The study participants were asked to wear low vision simulators (foggy goggles) during the study approximate 20/200 vision or worse. While wearing the low vision simulator, they navigated a controlled environment. The participants walked along a pressure mat with random panels to the left, right, and at the end of the walkway to assess the effectiveness of the wearable echolocation device in terms of navigational awareness. The participants were observed via gait termination analysis, electromyogram of key muscles involved in gait termination, ease of navigation throughout the course, and self-reported confidence. The participants navigated the controlled environment with and without the wearable echolocation device. The data table containing electronic pressure mat data from the study shows that (N=13) participants using the wearable echolocation device (Mean G+E) were able to detect objects in front of them more quickly than without the device (Mean G). As a result, the participants terminated their walking earlier and demonstrated a safer stopping behavior.

| Gait Metric | Mean G + E | Mean G | p-value |
|---|---|---|---|
| Step Length (cm) | 20.15 | 25.47 | 0.0041 |
| Velocity (cm/sec) | 21.57 | 32.84 | 0.0001 |
| Stride Length (cm) | 41.33 | 53.02 | 0.0059 |
| Stance Time (sec) | 2.46 | 1.99 | 0.037 |
| Swing Time (sec) | 0.356 | 0.447 | 0.034 |
| Double Support % | 60.46% | 49.42% | 0.00004 |
| Double Support Time (sec) | 1.99 | 1.45 | 0.021 |
| Cadence (steps/min) | 61.3 | 72.76 | 0.094 |

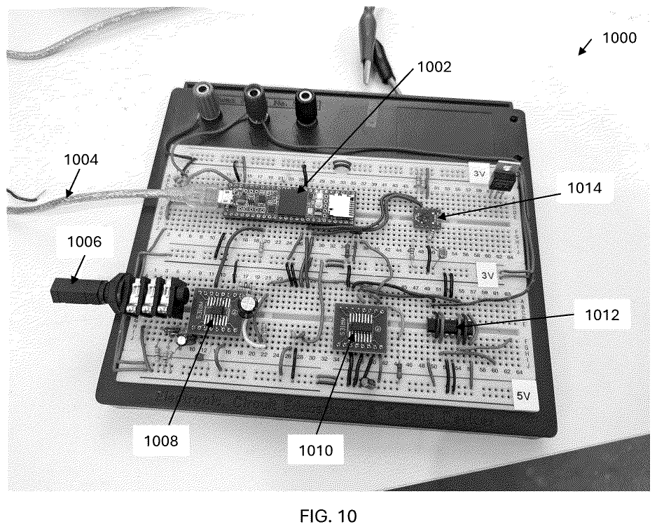

Referring to FIG. 10, an image of a breadboad circuit 1000 showing some of the components of a wearable echolocation device in accordance with one embodiment of the present disclosure is shown. A microcontroller 1002 (a Teensy 4.1 development board is shown in this non-limiting example), is connected to the untrasonic tranducers (not shown) via USB cable 1004. A 3.5 mm to ¼″ audio jack adapter 1006 is also included. A 555 timer 1008 is used to generate a 40 KHz carrier and modulated with an audio signal. Hex inverter 1010 is used a a buffer to send feeback to the microcontroller 1002 and also send a signal the the h-bridge ultrasonic speaker driver 1012. Analog-to-digital converter 1014 is used to read a photodiodiode (not shown).

Numerous embodiments can be implemented based on the presented disclosure. For example, in one embodiment of the present disclosure, a wearable echolocation system includes a set of ultrasonic transducers configured to emit parametric sound waves, and an enclosure containing the set of ultrasonic transducers. The enclosure is configured to be worn by a user without obscuring vision of the user.

In one aspect, the enclosure is configured to be worn with a lanyard. In another aspect, the enclosure is configured to be coupled to a mobility aid. In another aspect, the enclosure is handheld. In another aspect, the enclosure does not interfere with a user's ability to navigate in an environment. In another aspect, the parametric sound waves include a white noise or version thereof, one or more desired sound frequencies or a customizable audio pattern. In another aspect, the system further includes an analog synthesizer coupled to the set of ultrasonic transducers, wherein the analog synthesizer modulates a frequency of the directional sound waves based on light or sound information. In another aspect, the system further includes a photoresistor coupled to at least one of the analog synthesizer, or a digital audio interface, wherein the photoresistor provides the light information. In another aspect, the system further includes a microphone. In another aspect, the microphone is configured to generate a directional sound signature of the user. In another aspect, the system further includes a headphone communicably coupled to an auxiliary port which is communicably coupled to the microphone, wherein the microphone is configured to record a reflected audible signal from an environment that is provided to the headphone via the auxiliary port. In another aspect, the system further includes an audio amplifier coupled to the analog synthesizer. In another aspect, the system further includes a microcontroller coupled to the audio amplifier and the set of ultrasonic transducers. In another aspect, the system further includes a digital audio player and volatile memory card reader coupled to the analog synthesizer. In another aspect, the system further includes a microphone that captures the echolocation signal (the reflected sound). In another aspect, the system contains a microcontroller that processes the echolocation signal and exports the processed sound to an auxiliary port. In another aspect, the system contains an auxiliary port that can be connected to a headphone. In another aspect, the system contains a voltage control oscillator for frequency tunning to drive the set of ultrasonic transducers. In another aspect, the system contains audio controls and voltage regulators. In another aspect, the system contains an audio interface with potentiometers. In another aspect, the system can be coupled to another device with a Bluetooth signal.

The wearable echolocation devices as depicted herein are merely illustrative implementations of the present technology. Thus, the descriptions thereof that precede are intended to be only descriptions of illustrative examples of the present technology. These descriptions are not intended to define the scope or set forth the bounds of the present technology. In some cases, what are believed to be helpful examples of modifications to the wearable echolocation device may also be set forth above. This is done merely as an aid to understanding, and, again, not to define the scope or set forth the bounds of the present technology. These modifications are not an exhaustive list, and, as a person skilled in the art would understand, other modifications are likely possible. Further, where no examples of modifications have been set forth, it should not be interpreted to mean that no modifications are possible and/or that what is described is the sole manner of implementing that element of the present technology. As a person in the art of the present technology may appreciate, multiple variations as to how wearable echolocation devices are implemented may be envisioned without departing from the scope of the present technology.

It should be emphasized that the above-described embodiments of the present disclosure are merely possible examples of implementations, set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

What is claimed is:

1. A wearable echolocation system comprising:
a set of ultrasonic transducers configured to emit parametric sound waves; and
an enclosure containing the set of ultrasonic transducers, wherein the enclosure is configured to be worn by a user without obscuring vision of the user.

2. The wearable echolocation system of claim 1, wherein the enclosure is configured to be worn with a lanyard.

3. The wearable echolocation system of claim 1, wherein the enclosure is configured to be coupled to a mobility aid.

4. The wearable echolocation system of claim 1, wherein the enclosure is handheld.

5. The wearable echolocation system of claim 1, wherein the enclosure does not interfere with a user's ability to navigate in an environment.

6. The wearable echolocation system of claim 1, wherein the parametric sound waves comprise a white noise or version thereof, one or more desired sound frequencies or a customizable audio pattern.

7. The wearable echolocation system of claim 1, further comprising an analog synthesizer coupled to the set of ultrasonic transducers, wherein the analog synthesizer modulates a frequency of the parametric sound waves based on light or sound information.

8. The wearable echolocation system of claim 7, further comprising a photoresistor coupled to at least one of the analog synthesizer or a digital audio interface, wherein the photoresistor provides the light information.

9. The wearable echolocation system of claim 1, further comprising a microphone.

10. The wearable echolocation system of claim 9, wherein the microphone is configured to generate a directional sound signature of the user.

11. The wearable echolocation system of claim 9, further comprising a headphone communicably coupled to an auxiliary port which is communicably coupled to the microphone, wherein the microphone is configured to record a reflected audible signal from an environment that is provided to the headphone via the auxiliary port.

12. The wearable echolocation system of claim 7, further comprising an audio amplifier coupled to the analog synthesizer.

13. The wearable echolocation system of claim 7, further comprising a microcontroller coupled to the audio amplifier and the set of ultrasonic transducers.

14. The wearable echolocation system of claim 7, further comprising a digital audio player and volatile memory card reader coupled to the set of ultrasonic transducers.

15. A method of providing a wearable echolocation for a user comprising:
providing the wearable echolocation system to the user without obscuring a vision of the user, wherein the wearable echolocation system comprises a set of ultrasonic transducers configured to emit parametric sound waves, and an enclosure containing the set of ultrasonic transducers;
generating and emitting the parametric sound waves using the set of ultrasonic transducers;
receiving a reflected sound from one or more objects in response to the parametric sound waves; and
providing the reflected sound to the user.

16. The method of claim 15, wherein the reflected sound contains varying wavelengths depending on a distance of the one or more objects and the ultrasonic tranducers.

17. The method of claim 15, wherein the parametric sound waves are directional or focused.

18. The method of claim 15, wherein the parametric sound waves comprise a recorded or customizable audio pattern.

19. The method of claim 15, further comprising modifying the parametric sound waves.

20. The method of claim 15, further comprising modulating a frequency of the parametric sound waves based on detected light level(s).

21. The method of claim 15, wherein the parametric sound waves comprise a white noise or version thereof, one or more desired sound frequencies or a customizable audio pattern.

22. The method of claim 15, wherein the user uses the reflected sound to avoid the one or more objects.
